(19) United States
(12) Patent Application Publication
(10) Pub. No.: US 2026/0343669 A1
(43) Pub. Date: Oct. 29, 2026

(54) NEURAL NETWORK-BASED DISCONTINUOUS TRANSMISSION DETECTION IN WIRELESS NETWORKS

(71) Applicant: Rakuten Symphony, Inc., Tokyo (JP)

(72) Inventors: Keerthi Kumar Srinivas, Bangalore (IN); Raghavendra Madanahally Ramakrishna, Bangalore (IN); Rajesh Girmalla Teli, Bangalore (IN); Ronak Bharatkumar Lalwala, Bangalore (IN)

(21) Appl. No.: 19/192,610

(22) Filed: Apr. 29, 2025

(51) Int. Cl. H04W 76/28

(52) U.S. Cl. CPC H04W 76/28

(57) ABSTRACT

A system includes a radio unit and a distributed unit that is connected to the radio unit. The distributed unit is configured to receive samples of baseband signals that are output by the radio unit during a first uplink window allocated to user equipment (UE). The distributed unit processes these samples using a machine learning model to obtain a discontinuous transmission (DTX) decision. If the DTX decision indicates that the samples correspond to DTX event, the distributed unit will suspend the receiver processing for that UE and notify higher layers regarding the DTX decision.

### FIELD

The present disclosure relates to neural network-based discontinuous transmission detection in wireless networks.

### BACKGROUND

The information disclosed in this background section is only for enhancement of understanding of the general background of the disclosure and should not be taken as an acknowledgement or any form of suggestion that this information forms the prior art already known to a person skilled in the art.

In a cellular wireless network, the network will schedule a window for user equipment (UE) to send an uplink (UL) transmission to a node of the network, e.g., a gNodeB and corresponding radio unit (RU). Failure of the UE to decode the UL assignment resulting in no transmission on the corresponding allocated UL resource is referred to as a discontinuous transmission (DTX) event and, in response, the node may suspend further receiver processing for that UE. Often it can be difficult to discern between a UL transmission with low signal-to-noise ratio (SNR) and failure of the UL transmission by the UE.

### SUMMARY

In one aspect, a system includes an antenna and a distributed unit that is connected to the RU. The distributed unit is configured to receive samples of baseband signals that are output by the RU during an uplink window allocated to user equipment (UE). The distributed unit processes these samples using a neural network to obtain a discontinuous transmission (DTX) decision. If the decision indicates that the samples correspond to a DTX event, the distributed unit will suspend receiver processing for that UE and communicate the DTX decision to higher layers.

In another aspect, a method includes receiving, by a distributed unit (DU), samples of baseband signals output by a radio unit in a cellular communication network during an uplink window allocated to user equipment (UE), the samples including complex valued samples according to quadrature encoding. The method further includes processing, by the DU, the samples using a neural network to obtain a discontinuous transmission (DTX) decision. The DU determines that the decision indicates that the samples correspond to a DTX event and, in response, suspends receiver processing for that UE and communicates the DTX decision to higher layers.

In another aspect, a non-transitory computer-readable medium stores executable code that, when executed by a computing device, causes the computing device to receive samples of baseband signals output by an RU in a cellular communication network during an uplink window allocated to user equipment (UE). These samples include complex valued samples according to quadrature encoding. The computing device processes the samples using a neural network to obtain a discontinuous transmission (DTX) decision. The computing device determines that the DTX decision indicates the samples correspond to a DTX event. In response to this determination, the computing device suspends receiver processing of the UE and indicates the DTX decision to higher layers.

### BRIEF DESCRIPTION OF THE DRAWINGS

Features, aspects, and advantages of embodiments of the disclosure will be described below with reference to the accompanying drawings, in which like reference numerals denote like elements, and wherein:

FIG. 1 is a schematic block diagram of a cellular communication network;

FIG. 2 is a process flow diagram of a method for scheduling and receiving uplink transmissions from user equipment;

FIG. 3 is a process flow diagram of a method for training a neural network in accordance with an embodiment of the present invention; and

FIG. 4 is a process flow diagram of a method for detecting discontinuous transmission in accordance with an embodiment of the present invention;

FIG. 5 is a schematic block diagram of a neural network for detecting discontinuous transmission in accordance with an embodiment of the present invention; and

FIG. 6 is a schematic block diagram of an example computing device suitable for implementing methods in accordance with embodiments of the disclosure

### DETAILED DESCRIPTION

The following detailed description of example embodiments refers to the accompanying drawings. The present disclosure provides illustrations and descriptions but is not intended to be exhaustive or to limit the implementations to the precise form disclosed. Modifications and variations are possible in light of the present disclosure or may be acquired from practice of the implementations. Further, one or more features or components of one embodiment may be incorporated into or combined with another embodiment (or one or more features of another embodiment). Additionally, the flowchart and description of operations provided below relate to at least one of the embodiments in the present disclosure. It should be noted that it is possible to make other embodiments that do not exactly match the flowchart and its description. It is understood that in other embodiments one or more operations may be omitted, one or more operations may be added, one or more operations may be performed simultaneously (at least in part).

It will be apparent that systems and/or methods, described herein, may be implemented in different forms of hardware, software, or a combination of hardware and software. The actual specialized control hardware or software code used to implement these systems and/or methods should not limit their implementations. Thus, the operation and behavior of the systems and/or methods are described herein without reference to specific software code. It is understood that software and hardware may be designed to implement the systems and/or methods based on the description herein.

Even though particular combinations of features are recited in the claims and/or disclosed in the specification, the particular combinations are not intended to limit the disclosure of implementations. In fact, many of these features may be combined in ways not specifically recited in the claims and/or disclosed in the specification. Even if a dependent claim directly depends on only one claim, the present disclosure may indicate that the dependent claim is dependent on other claims in the claim set.

No element, act, or instruction used herein should be construed as critical or essential unless explicitly described as such. Also, as used herein, the articles “a” and “an” (in other words, nouns not mentioned in the plural) are intended to include one or more items, and may be used interchangeably with “one or more.” Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B],” “[A] and/or [B],” or “at least one of [A] or [B]” are to be understood as including only A, only B, or both A and B.

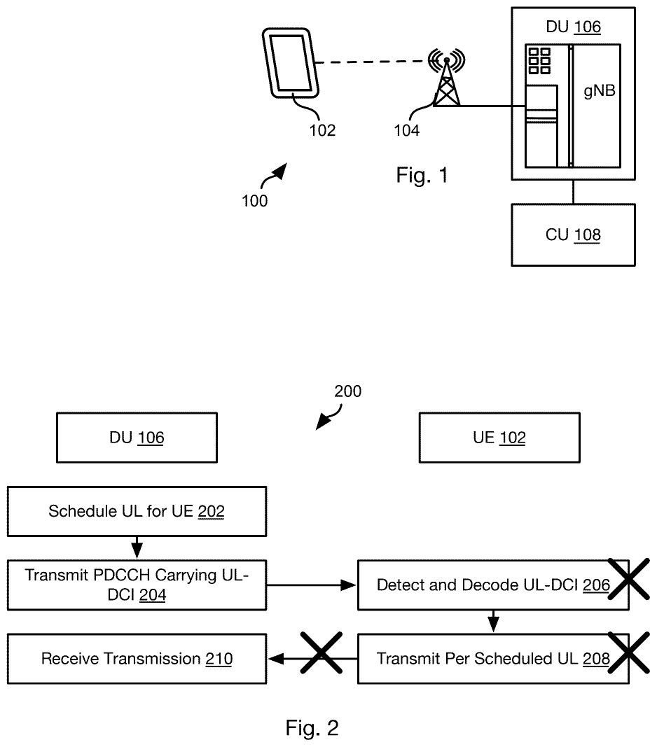

Referring to FIG. 1, in a cellular communication network 100 user equipment (UE) 102 transmits wireless signals to one or more radio units (RU) 104 coupled to a base station configured to manage generated signals to be transmitted over the RU 104 and to detect signals received by the RU 104. Each RU 104 may include one or more antennas or antenna arrays. The base station may be implemented as a distributed unit (DU) 106, which may include a gNodeB (gNB) in a fifth generation (5G) network. The data transmitted to the UE 102 and received from the UE 102 as well as managing a logical connection with the UE 102 according to a cellular communication protocol may be managed by the DU 106.

Multiple DUs 106 may be in data communication with a central unit (CU) 108. The CU 108 may implement higher layers of a wireless communication protocol, such as the 5G protocol. For example, the CU 108 may manage handoffs between DUs 106 due to movement of the UE 102 or some other reason.

Referring to FIG. 2, the DU 106 and the UE 102 may perform the illustrated method 200. The DU 106 may schedule an uplink (UL) transmission by the UE at step 202, e.g., a time window (UL window) and one or more carrier frequencies (hereinafter simply “carriers”) that the UE 102 is allowed to use to transmit data to the DU 106. The UL window may be specified in a number of physical resource blocks (PRB) allocated to the UE 102, such as 10 PRBs or other number of PRBs. The DU 106 may generate a UL downlink control information (UL-DCI) message that indicates the time window, the carriers, and possibly other information describing the communication channel between the UE 102 and the DU 106. The UL-DCI may be included in a physical downlink control channel (PDCCH) message that is transmitted to the UE 102 at step 204.

The UE 102 detects and decodes the UL-DCI at step 206 and transmits a UL transmission at step 208 during the UL window and using the carriers or other channel information included in the UL-DCI. The DU 106 receives the transmission at step 210 and decodes the information.

In some instances, the DU 106 does not receive a transmission from the UE 102 during the window indicated in the UL-DCI. For example, the UE 102 may not receive the PDCCH and therefore not perform step 208. The UE 102 may experience a failure such that the UE 102 fails to perform step 208 and/or step 210. Noise, obstructions, or other factors affecting the communication channel may prevent a transmission from step 210 from reaching the DU 106.

Failure of the DU 106 to receive a transmission from a UE 102 during the scheduled window is known as a discontinuous transmission (DTX) event. In response to a DTX, the DU 106 may suspend further receiver processing to the UE 102 and indicate the same to the higher layers to take other measures to reestablish a connection to the UE 102.

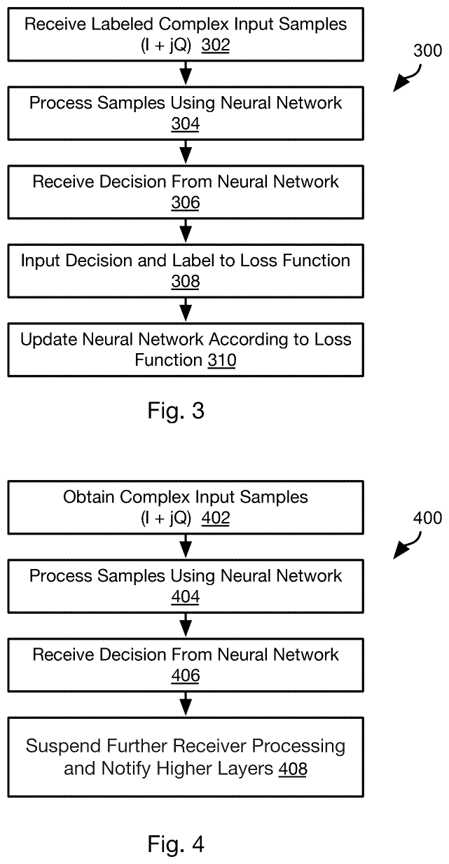

FIGS. 3 to 5 illustrate an approach for detecting DTX events, e.g., distinguishing a DTX event from an actual UL transmission from the UE 102 that has a low signal-to-noise ratio (SNR).

FIG. 3 illustrates a method 300 for training a machine learning model, such as a neural network or other type of machine learning model, to distinguish between UL transmissions and DTX events.

The method 300 may include receiving, at step 302, training data entries that include labeled complex input samples, e.g., (I+jQ) sample pairs and a label. The set of sample pairs may be obtained by quadrature demodulation. Quadrature demodulation may include processing an electrical signal received by the RU 104 by mixing the electrical signal with a carrier to obtain a first mixed signal and mixing the electrical signal with a 90-degree shifted version of the carrier to obtain a second mixed signal. The first and second mixed signals may then be sampled to obtain the I and Q samples, respectively. The quadrature demodulation may be performed in the analog or digital domain. The set of samples may include a number of pairs of samples typically received during an UL window. For example, there may be 12 samples per PRB of the UL window in some embodiments. If the window includes 12 PRBs, there will therefore be 168 pairs of samples. Any number of PRBs and corresponding pairs of samples may be used.

The label may indicate whether the set sample pairs include a UL transmission or not. For example, data obtained from a UE 102 indicating whether the UE 102 actually made a UL transmission during a UL window allocated to the UE 102 by a DU 106 may be correlated to a set of sample pairs obtained by the DU 106 for the UL window. The set of sample pairs obtained during the UL window may then be added to a training data entry along with a label indicating whether the UE 102 actually made a UL transmission during the UL window. In some embodiments, the UE 102 may be specially programmed to retain the data, or the data logged during normal operation may be used. The UE 102 may be specially programmed to periodically refrain from transmitting during UL windows allocated to the UE 102 in order to generate training data entries corresponding to DTX events.

The training data entries may be obtained for a plurality of scenarios. Scenarios may be defined according to some or all of the following parameters: distance between UE 102 and RU 104, speed of the UE 102 (e.g., doppler shift), timing offset, channel conditions (line of sight, scattering, etc.). Training data entries may be generated by simulating transmission from a UE 102 to an RU 104 for a plurality of scenarios defined according to some or all of these parameters.

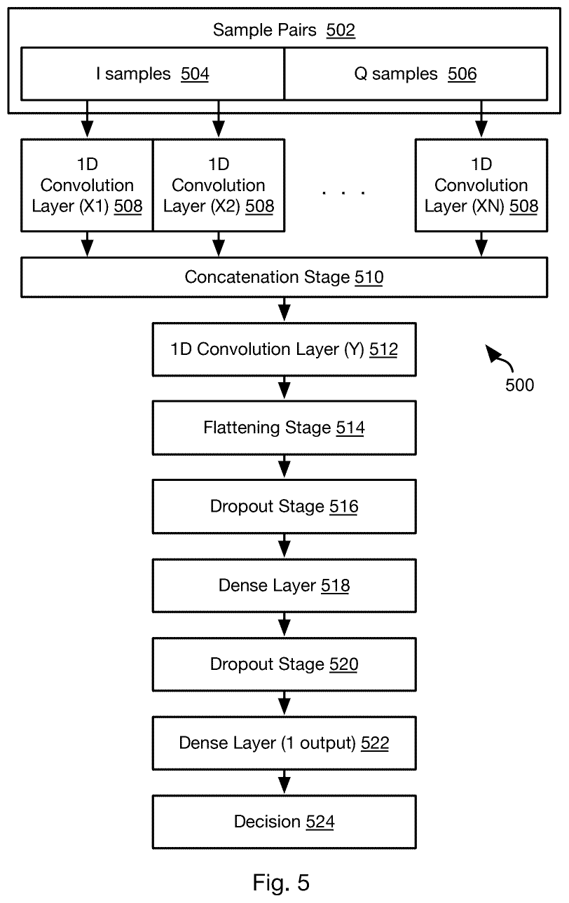

The set of sample pairs of a training data entry may be processed at step 304 using a neural network, such as the neural network described below with respect to FIG. 5. A decision is obtained at step 306 as a result of the processing at step 304, e.g., whether the set of sample pairs indicate a UL transmission or DTX event. The decision and the label for the training data entry may then be input to a loss function at step 308. The output of the loss function may be used at step 310 to update the neural network.

Equation (1) illustrates an example loss function in which:

a=weight used for signal detction (UL Transmission)

b=weight used for noise detection (DTX event)

yₜᵣᵤₑ=true label of the training data entry y_{pred}=decision¿ the neural network

[symbol]

=−[a*yₜᵣᵤₑ*ln(y_{pred})+b*(1−yₜᵣᵤₑ)*ln(1−y_{pred})] (1)

The values of a and b may be used to bias the neural network, e.g., a>b indicates a bias toward detecting a UL transmission such that there will be more false positives indicating a UL transmission and decisions indicating UL transmission are more likely to be correct. For b>a, the opposite is the case: the neural network will have a bias toward detecting DTX events such that there will be more false positives indicating DTX events and decisions indicating DTX events are more likely to be correct.

FIG. 4 illustrates an example method 400 for using a machine learning model trained according to the method 300, such as a neural network or other type of machine learning model. The method 400 may be performed by the DU 106.

The method 400 may include receiving, at step 402, a set of sample pairs, e.g., (I+jQ) sample pairs obtained by the DU 106 from baseband samples extracted by the RU 104 during a UL window allocated to a UE 102. The set of sample pairs may be processed using a neural network at step 404. A decision is received from the neural network at step 406 that represents the result of processing the set of sample pairs. The DU 106 may then act on the decision at step 408. For example, if the decision indicates a DTX event, the DU 106 may, for example, suspend further receiver processing to the UE 102 and notify higher layers of the DTX event. Higher layers may respond to notification of the DTX event by attempting to reconnect to the UE 102, such as using a different DU 106 having the UE 102 within range of the RU 104 thereof. The higher layers may include functions performed by a central unit (CU) to which the DU 106 and possibly other DUs 106 are connected. For example, higher layers may include layer 2 protocols, such as packet data convergence protocol (PDCP), radio link control (RLC), and/or medium access control (MAC) or layer 3 protocols such as the network layer and/or radio resource control (RRC). The higher layers may part of base station (e.g., eNodeB or gNodeB) or by the CU 108 and/or DU 106 where a disaggregated architecture is used.

In some embodiments, the DU 106 suspends allocation of UL windows in response to the number of DTX events exceeding a threshold. If the decision indicates a UL transmission, the DU 106 may process the samples as a UL transmission, e.g., attempt to extract data therefrom, and may continue to allocate UL windows to the UE 102.

FIG. 5 illustrates an example neural network 500 that may be trained according to the method 300 and utilized according to the method 400. The neural network 500 may receive sample pairs 502 including I samples 504 and Q samples 506 from a set of sample pairs.

The sample pairs 502, e.g., a two-dimensional array including the I samples 504 and the Q samples 506, may be input to a plurality of one-dimensional (1D) convolution layers 508. The 1D convolution layers 508 may each include batch normalization. The 1D convolution layers 508 may include a reduction in dimension such that the dimension of the output of each 1D convolution layer 508 is less than the dimension of the sample pairs 502. For example, the 1D convolution layers 508 may be reduced in size by a factor of two or more (e.g., a stride of two or more).

In the illustrated embodiment, each of the 1D convolution layers 508 uses a kernel of a different size, e.g., sizes from X1 to XN, where N is the number of 1D convolution layers 508. For example, X1 may be 3, X2 may be 5, X3 may be 7, X4 may be 9, and XN=X5 may be 11. Using X1=3 to X5=11, experiments conducted by the inventors have been able to achieve an error of 1% in discerning between DTX events and UL transmissions. The total number of 1D convolution layers 508 may be 5 or greater and the change in size of the kernels between 1D convolution layers 508 may be two or greater. The output of each convolution layer 508 may therefore be a two-dimensional (2D) array with the long dimension thereof being half of the long dimension of the sample pairs 502. For example, a 2×M array at the input of a convolution layer 508 will result in a 2×(M/2) array at the output.

The outputs of the 1D convolution layers 508 may be input to a concatenation stage 510, which converts the outputs into a single 2D array, e.g., the N 2×(M/2) arrays will become a (2*N)×(M/2) array. The array output from the concatenation stage 510 includes all features detected using each of the 1D convolution layers 508.

The array output by the concatenation stage 510 may be input to another 1D convolution layer 512. The 1D convolution layer 512 may include batch normalization. The 1D convolution layer 512 may include a reduction in dimension such that a dimension of the output of the 1D convolution layer 512 is less than a corresponding dimension of the array output from the concatenation stage 510. For example, the 1D convolution layer 512 may have a stride of two or more. The (2*N)×(M/2) array that is input to the 1D convolution layer 512 will result in a (2*N)×(M/4) array at the output of the 1D convolution layer 512. The 1D convolution layer 512 may have a kernel size Y. For example, Y may be equal to any of X1 to XN. For example, Y may be equal to X1, e.g., 3 in the example given above.

The output of the 1D convolution layer 512 may be input to a flattening stage 514. The flattening stage 514 may convert the output of the 1D convolution layer 512 to a 1D array, e.g., the (2*N)×(M/4) array may be converted to a N*M/2 array. The flattening stage 514 may be a simple rearrangement of the data in the output of the 1D convolution layer 512.

The output of the flattening stage 514 may be processed by a dropout stage 516. The dropout stage 516 may be present only during the training process and may randomly prune (set to zero) values from the 1D array output from the flattening stage 514 in order to avoid overfitting to training data. For example, the pruning ratio (amount removed to the total number of elements in the 1D array) may be 0.38.

The outputs of the dropout stage 516 (or outputs of the flattening stage 514 during utilization) are processed by a dense layer 518. The dense layer 518 may be a fully connected layer in which each input to the dense layer 518 is connected to each output of the dense layer 518, e.g., each output of the dense layer 518 is the result of multiplying the inputs to the dense layer 518 by a set of weights corresponding to that output. The dense layer 518 may include multiple outputs, such as 64 or greater.

During training, the outputs of the dense layer 518 may be processed by a dropout stage 520 in which randomly selected outputs of the dense layer 518 are set to zero.

The outputs of the dropout stage 520 (or the outputs of the dense layer 518 during utilization) may be input into to another dense layer 522. The dense layer 522 may be a fully connected layer with a single output 524, i.e., a decision of the neural network 500 indicating whether the sample pairs 502 correspond to a DTX event or a UL transmission.

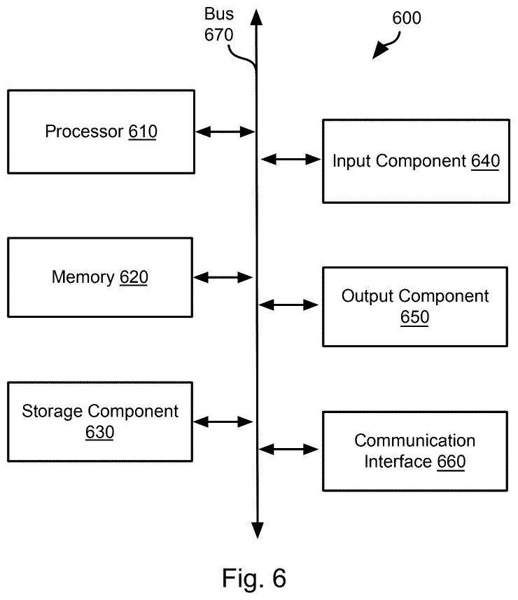

FIG. 6 illustrates an embodiment of a computing device 600 that may be used to implement some or all of the components of the cellular communication network 100. As shown in FIG. 6, the computing device 600 includes a processor 610, a memory 620, a storage component 630, an input component 640, an output component 650, a communication interface 660, and a bus 670.

The processor 610, as used herein, means any type of computational circuit that may comprise hardware elements and software elements. The processor 610 may be embodied as a multi-core processor, a single core processor, or a combination of one or more multi-core processors and/or one or more single core processors, a distributed processing system, or the like. The processor 610 may be a Central Processing Unit (CPU), a graphics processing unit (GPU), an accelerated processing unit (APU), an application-specific integrated circuit (ASIC), or another type of processing component.

Memory 620 includes a non-transitory computer readable medium. Memory 620 includes a random-access memory (RAM), a read only memory (ROM), and/or another type of dynamic or static storage device (e.g., a flash memory, a magnetic memory, and/or an optical memory) that stores information and/or instructions for use by processor 610. The memory 620 comprises machine-readable instructions which are executable by the processor 610. These machine-readable instructions when executed by the processor 610 cause the processor 610 to perform one or more method steps of an embodiment described above.

Storage component 630 stores information and/or software related to the operation and use of the device 600. For example, storage component 630 may include a hard disk (e.g., a magnetic disk, an optical disk, a magneto-optic disk, and/or a solid-state disk), a compact disc (CD), a digital versatile disc (DVD), a floppy disk, a cartridge, a magnetic tape, and/or another type of non-transitory computer-readable medium, along with a corresponding drive.

Input component 640 is configured to receive information, such as user input. For example, the input component 640 may include, but not be limited to, a touch screen display, a keyboard, a keypad, a mouse, a button, a switch, and/or a microphone. Additionally, or alternatively, the input component 640 may include a sensor for sensing information (e.g., a global positioning system (GPS), an accelerometer, a gyroscope, and/or an actuator).

Output component 650 is configured to provide output information from the device 600. For example, the output component 650 may be, but not limited to, a display, a speaker, instructions to an external device, and/or one or more light-emitting diodes (LEDs).

Communication interface 660 is an interface that provides a communication connection to other devices, such as external devices and internal devices. The connection by the communication interface 660 can be a wired connection, a wireless connection, or a combination of wired and wireless connections, and can be a direct connection or an indirect connection via a communication network that exists between the device 600 and other devices. In other words, the standard of the communication interface 660 is not limited.

The bus 670 acts as an interconnect between the processor 610, the memory 620, the storage component 630, the input component 640, the output component 650, and the communication interface 660 of the device 600. The bus 670 may include a wired interconnection or a wireless interconnection.

The number and arrangement of components shown in FIG. 6 are provided as an example. In practice, device 600 may include additional components, fewer components, different components, or differently arranged components than those shown in FIG. 6. Additionally, or alternatively, a set of components (e.g., one or more components) of device 600 may perform one or more functions described as being performed by another set of components of device 600. Further, one or more method steps described in any of the embodiments may be performed utilizing a plurality of devices 600 in communication with one another.

In a first example embodiment, a system includes: radio unit; and a distributed unit coupled to the radio unit and configured to: receive samples of baseband signals output by the radio unit during an uplink window allocated to user equipment (UE); process the samples using a neural network to obtain a discontinuous transmission (DTX) decision; and if the DTX decision indicates that the samples correspond to a DTX event, suspending receiver processing for the UE and communicating the DTX decision to higher layers.

In a second example embodiment of the first example embodiment, the samples include complex valued samples according to quadrature encoding.

In a third example embodiment of the second example embodiment, the neural network is configured to process the samples using a plurality of parallel convolution layers.

In a fourth example embodiment of the third example embodiment, the plurality of parallel convolution layers are one-dimensional convolution layers.

In a fifth example embodiment of the fourth example embodiment, the plurality of parallel convolution layers have differently sized kernels.

In a sixth example embodiment of the fifth example embodiment, the kernels range in size from three to eleven.

In a seventh example embodiment of the fifth example embodiment, the neural network includes a concatenation layer configured to concatenate outputs of the plurality of parallel convolution layers.

In an eighth example embodiment of the seventh example embodiment, the neural network includes a flattening layer configured convert outputs of the concatenation layer to a one-dimensional array.

In a ninth example embodiment of the eighth example embodiment, the neural network includes one or more dense layers configured to process the one-dimensional array, a last layer of the one or more dense layers including a single output, the single output being the DTX decision of the machine learning model.

In a tenth example embodiment of the ninth example embodiment, the one or more dense layers include a first dense layer configured to receive the one-dimensional array and configured to generate multiple outputs and a second dense layer configured to receive the multiple outputs and output the single output.

In an eleventh example embodiment. A method includes: receiving, by a distributed unit (DU), samples of baseband signals output by a RU in a cellular communication network during an uplink window allocated to user equipment (UE), the samples including complex valued samples according to quadrature encoding; processing, by the DU, the samples using a neural network to obtain a discontinuous transmission (DTX) decision; determining, by the DU, that the DTX decision indicates that the samples correspond to a DTX event; and in response to determining that the decision indicates that the samples correspond to a DTX event, suspending receiver processing for that UE and communicating the DTX decision to higher layers.

In a twelfth example embodiment of the eleventh example embodiment, processing the samples using the neural network to obtain the decision comprises processing the samples using a plurality of parallel convolution layers.

In a thirteenth example embodiment of the twelfth example embodiment, the plurality of parallel convolution layers are one-dimensional convolution layers.

In a fourteenth example embodiment of the thirteenth example embodiment, the plurality of parallel convolution layers have differently sized kernels.

In a fifteenth example embodiment of the fourteenth example embodiment, processing the samples using the neural network to obtain the decision further comprises processing outputs of the plurality of convolution layers using a concatenation layer and processing outputs of the concatenation layer using a flattening layer to obtain a one-dimensional array.

In a sixteenth example embodiment of the fifteenth example embodiment, processing the samples using the neural network to obtain the decision further comprises processing the one-dimensional array using one or more dense layers, a last layer of the one or more dense layers including a single output, the single output being the decision.

In a seventeenth example embodiment of the sixteenth example embodiment, the one or more dense layers include a first dense layer configured to receive the one-dimensional array and configured to generate multiple outputs and a second dense layer configured to receive the multiple outputs and output the single output.

In an eighteenth example embodiment, a non-transitory computer-readable medium storing executable code that, when executed by a computing device, causes the computing device to: receive samples of baseband samples output by a RU in a cellular communication network during an uplink window allocated to user equipment (UE), the samples including complex valued samples according to quadrature encoding; process the samples using a neural network to obtain a discontinuous transmission (DTX) decision; determine that the DTX decision indicates that the samples correspond to a DTX event; and in response to determining that the decision indicates that the samples correspond to a DTX event, suspend receiver processing of the UE and indicating the DTX decision to higher layers.

In a nineteenth example embodiment of the eighteenth example embodiment, the neural network comprises multiple parallel convolution layers each having a different kernel size.

In a twentieth example embodiment of the nineteenth example embodiment, the multiple parallel convolution layers are one-dimensional convolution layers.

1. A system comprising:
a radio unit; and
a distributed unit coupled to the radio unit and configured to:
receive samples of baseband signals output by the radio unit during a first uplink window allocated to user equipment (UE);
process the samples using a neural network to obtain a discontinuous transmission (DTX) decision; and
if the DTX decision indicates that the samples correspond to a DTX event, suspending receiver processing for the UE and communicating the DTX decision to higher layers.

2. The system of claim 1, wherein the samples include complex values which are converted to real values by separating real and imaginary parts.

3. The system of claim 2, wherein the neural network is configured to process the samples using a plurality of parallel convolution layers.

4. The system of claim 3, wherein the plurality of parallel convolution layers are one-dimensional convolution layers.

5. The system of claim 4, wherein the plurality of parallel convolution layers have differently sized kernels.

6. The system of claim 5, wherein the kernels range in size from three to eleven.

7. The system of claim 5, wherein the neural network includes a concatenation layer configured to concatenate outputs of the plurality of parallel convolution layers.

8. The system of claim 7, wherein the neural network includes a flattening layer configured convert outputs of the concatenation layer to a one-dimensional array.

9. The system of claim 8, wherein the neural network includes one or more dense layers configured to process the one-dimensional array, a last layer of the one or more dense layers including a single output, the single output being the DTX decision of the neural network.

10. The system of claim 9, wherein the one or more dense layers include a first dense layer configured to receive the one-dimensional array and configured to generate multiple outputs and a second dense layer configured to receive the multiple outputs and output the single output.

11. A method comprising:
receiving, by a distributed unit (DU), samples of baseband signals output by a radio unit in a cellular communication network during an uplink window allocated to user equipment (UE), the samples including complex values;
processing, by the DU, the samples using a neural network to obtain a discontinuous transmission (DTX) decision;
determining, by the DU, that the DTX decision indicates that the samples correspond to a DTX event; and
in response to determining that the DTX decision indicates that the samples correspond to a DTX event, suspending receiver processing for the UE and communicating the DTX decision to higher layers.

12. The method of claim 11, wherein processing the samples using the neural network to obtain the DTX decision comprises processing the samples using a plurality of parallel convolution layers.

13. The method of claim 12, wherein the plurality of parallel convolution layers are one-dimensional convolution layers.

14. The method of claim 13, wherein the plurality of parallel convolution layers have differently sized kernels.

15. The method of claim 14, wherein processing the samples using the neural network to obtain the DTX decision further comprises processing outputs of the plurality of parallel convolution layers using a concatenation layer and processing outputs of the concatenation layer using a flattening layer to obtain a one-dimensional array.

16. The method of claim 15, wherein processing the samples using the neural network to obtain the DTX decision further comprises processing the one-dimensional array using one or more dense layers, a last layer of the one or more dense layers including a single output, the single output being the DTX decision.

17. The method of claim 16, wherein the one or more dense layers include a first dense layer configured to receive the one-dimensional array and configured to generate multiple outputs and a second dense layer configured to receive the multiple outputs and output the single output.

18. A non-transitory computer-readable medium storing executable code that, when executed by a computing device, causes the computing device to:
receive samples of baseband signals output by a radio unit in a cellular communication network during an uplink window allocated to user equipment (UE);
process the samples using a neural network to obtain a discontinuous transmission (DTX) decision;
determine that the DTX decision indicates that the samples correspond to a DTX event; and
in response to determining that the DTX decision indicates that the samples correspond to a DTX event, suspend receiver processing of the UE and indicating the DTX decision to higher layers.

19. The non-transitory computer-readable medium of claim 18, wherein the neural network comprises multiple parallel convolution layers each having a different kernel size.

20. The non-transitory computer-readable medium of claim 19, wherein the multiple parallel convolution layers are one-dimensional convolution layers.
